(19) United States
(12) Patent Application Publication
(10) Pub. No.: US 2002/0091737 A1
(43) Pub. Date: Jul. 11, 2002

(54) System and method for rules based media enhancement

(76) Inventor: Steven O. Markel, Highlands Ranch, CO (US)

Correspondence Address: The Law Offices of William W. Cochan, LLC, Suite 230, 3555 Stanford Road, Fort Collins, CO, 80525, US

(21) Appl. No.: 10/045,453

(22) Filed: Nov. 1, 2001

Related U.S. Application Data
(60) Provisional application No. 60/244,947, filed on Nov. 1, 2000.

(51) Int. Cl. G06F 11/30

(52) U.S. Cl. 707/513; 707/501.1

(57) ABSTRACT

A set of rules containing constraints and limitations of media display platforms is employed to define options in an enhancement-authoring program. Authoring actions implemented via the authoring program are checked to determine if a rule exists for the action. If a rule exists, a step associated with the rule is executed. The step may comprise issuing warnings, providing recommended values, providing suggestions, or indicating a set of permissible values. A rules based post processing routine may be employed to check file sizes, color relationships, or other enhancement aspects. The present invention may be implemented in conjunction with an authoring program, in conjunction with a display platform, or both. In one embodiment, rules are utilized by a display platform to convert enhancement variables to those suited to the display platform. The set of rules of the present invention may be implemented in a text file and may be compliant with XML.

### CROSS REFERENCE TO RELATED APPLICATIONS

This application claims benefit of U.S. provisional patent application number 60/244,947 entitled “A System and Method for Developing Rules Based Presentations for Interactive Platforms”, filed Nov. 1, 2000 by Steve 0. Markel, which is specifically incorporated herein by reference for all that it discloses and teaches.

### BACKGROUND OF THE INVENTION

a. Field of the Invention

The present invention relates to interactive and enhanced media as may be presented on a television or computer and, more particularly, to a set of rules that may be employed to accommodate differences and limitations of various presentation platforms.

b. Description of the Background

A program may be accompanied by additional information employed to enhance the program or to provide viewer interaction. Enhancements have historically included closed captioning and multilingual support. Advances in networking, computer systems, and video production have increased the number and types of enhancements that may be provided with a program or advertisement. Enhancements may include stock updates, news stories, Internet links, weather forecasts, bulletins, statistics, trivia, and other information. For example, a football game may include icons allowing viewing of team players, statistics, trivia and other information such as upcoming games. Web browsers, set-top-boxes, and intelligent televisions allow enhancement information to be presented in new ways, such as screen overlays and in windows, for example.

Enhanced television content may employ a combination of HTML (hypertext markup language), JavaScript, Java and other formats common to Internet page display. An enhanced display may comprise text, icons, graphics and images placed at locations on or in proximity to the television image. To produce an enhanced display, an author may create an enhancement file identifying each displayed element (such as text, icons, graphics and images), the location where each element is displayed and the time at which the element may be displayed. There are numerous constraints put upon the development of interactive content depending on the target platform. The target platform may be one of a plurality of browsers for streaming media, or one of a plurality of set-top boxes or interactive televisions.

There are numerous differences between platforms. Spacing between lines of text, text wrap and text alignment, placement of graphics, fonts, font size and color, plus the background color of text frames may vary between presentation platforms. The sizes of various form elements including buttons and drop down menus may also differ. Further, differences between television resolution and signal encoding as compared to computer monitors and high definition televisions result in constraints that differ between platforms. For example, a television cannot display the range of fonts or font sizes that a PC browser can display, and, whereas a PC browser can display “pure” red, a television cannot display pure colors without distortion of the presentation image.

An enhancement author may not know all limitations of all target platforms when creating enhanced content and a disparity between enhancements and platform capabilities may not be discovered until content is displayed at which time an image may not be displayed, or may not be displayed as intended. In the event an author knows platform limitations and constraints, one approach may be to “hard code” the variations into the development platform. With such a solution, adding an additional presentation platform (or supporting upgrades to existing platforms) can be a very time consuming, error prone, and costly process.

In order to efficiently and cost effectively support a wide range of presentation platforms, and to easily provide support for new platforms or upgrades to existing platforms, a new system and method for developing enhanced presentations is needed.

### SUMMARY OF THE INVENTION

The present invention overcomes the disadvantages and limitations of the prior art by employing a rules set comprising the different limitations, capabilities, and restrictions of a targeted set of platforms and by applying the set of rules to produce values suited to a target platform or a range of platforms. The present invention may be implemented at an authoring stage or may be implemented to process an existing presentation. Further, the present invention may be implemented in conjunction with authoring an enhancement or in conjunction with the display of enhancement by a display platform, or in conjunction with both authoring and display of enhancements.

The invention therefore may comprise a method for creating a media enhancement file comprising: establishing a set of rules describing at least one constraint for each of at least two display platforms, employing the set of rules to define options in an authoring program, employing the authoring program to perform an authoring action, and saving a media enhancement file.

The present invention may also employ an author monitoring function wherein a set of rules is checked for each authoring action performed, and if a rule exists for a particular action, a step or sequence of steps associated with that action may be executed. This provides real-time feedback to the user of an authoring system, allowing optimized choices for authoring to be implemented. Rules based post processing may be employed to check file size or other operational aspects of the enhancement. Further, the present invention may be implemented at both authoring and presentation stages wherein a set of rules may be implemented by a receiver platform such as a browser or set-top bix for example.

The present invention may be implemented as a text based file and may be compliant with XML (Extensible Markup Language). This provides simple creation and upgrades to rules sets and allows usage of other software development tools. By providing a system and method that automatically checks for authoring actions that conform to a target set of display platforms, the present invention allows an author to focus on creative content and not expend time, energy and money with concerns whether the interactive content will operate correctly on a targeted platform.

The present invention therefore may further comprise a system for authoring media enhancements comprising: a computer, an enhancement authoring program, a rules set; and a program operable to constrain an editing option in the enhancement authoring program to reflect a limitation in the rules set.

### DESCRIPTION OF THE FIGURES

In the figures,

FIG. 1 depicts a process for rules based presentation generation.

FIG. 2 illustrates rules based authoring program option definition.

FIG. 3 is a code example for checking an authoring action and applying a rule.

FIG. 4 depicts a method employing authoring and platform-based rules

### DETAILED DESCRIPTION OF THE INVENTION

Enhanced television content comprises images, text, graphics and sounds that may be rendered in conjunction with a television program. Enhanced television content is typically presented using a combination of HTML, JavaScript, Java and other web technologies. The level of support for these technologies varies by the targeted presentation platform, including the combination of client hardware, operating system, web browser and add-on software. A presentation platform may comprise a set top box, interactive television, computer, or other system operable to receive program signals and to process HTML and other code and to produce an image comprising a television image and enhancements. Program signals may comprise television broadcast signals, cable television signals, satellite signals, or other network transferred signals. Display capabilities may vary depending the type of presentation platform. Certain functions may or may not exist, or may be optimized on a given platform through the use of custom features. Variations in capability may include screen size and resolution, acceptable color combinations, graphics support, and version of HTML or JavaScript, for example. Providing concurrent support for the Internet or wireless handheld devices may introduce additional requirements and dependencies. The present invention overcomes the difficulties of supporting multiple platforms, each having a specific set of capabilities, by employing a set of rules that may be applied wholly or in part at an authoring stage, in a post processing stage, or by a presentation platform.

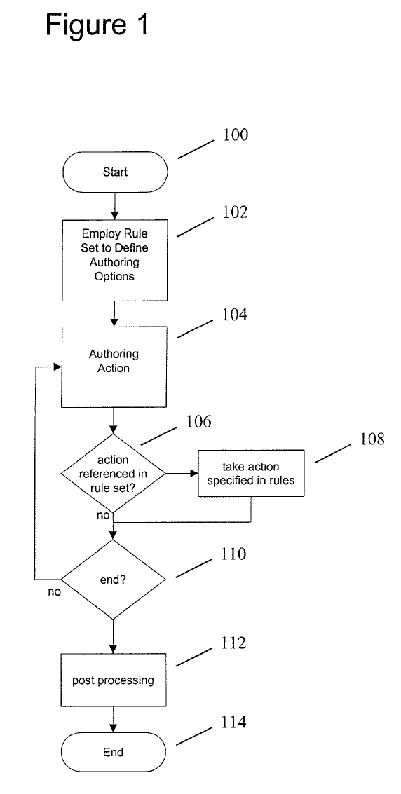

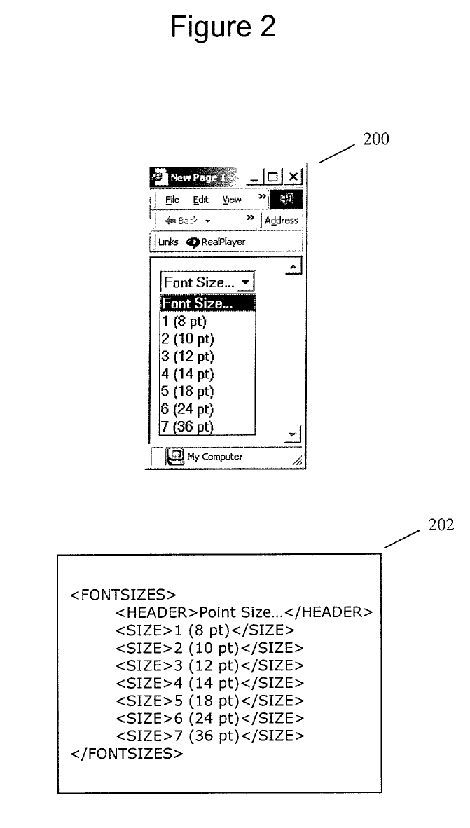

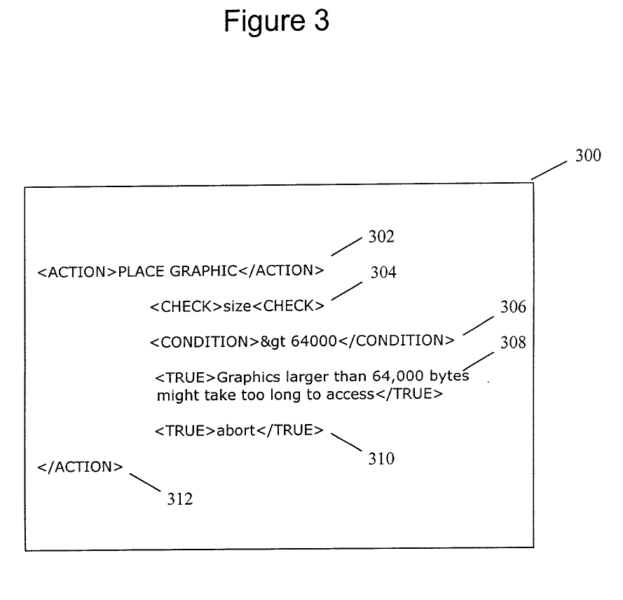

FIG. 1 depicts a process for rules based presentation generation. The process begins at step 100, and at step 102, a rules set may be employed to define options that are presented to a user of an authoring program. For example, the rules set may be employed to define text options, as shall be illustrated in FIG. 2. Continuing with FIG. 1, at step 104 a user of an authoring program may perform an action, such as selecting and placing a graphic image in a window of an authoring program, for example. At step 106 a check is performed to determine if rules exist for the action performed by the user in step 104. If rules exist for the action, processing continues at step 108 where processing defined by the rules may be applied. Steps 106 and 108 are further described in FIG. 3. If step 106 determines that rules do not exist for the action, processing continues at step 110 where a check is performed to determine if authoring is complete. If authoring is not complete, processing continues at step 104 where a new action may be performed. If step 110 determines that all actions are complete, processing continues at step 112 where post-processing may be applied. Such processing may include calculations or estimates of download time for enhancements, allowing the user to confirm that the level of detail of the enhancement is suited to the data transfer rates of the transmission system. Further post processing may be employed to access an existing file, created with a first set of target platform rules, and to update the file to add or remove other platforms.

FIG. 2 illustrates rules based authoring program option definition. Rules based option definition employs a set of rules to define the options presented to a user when utilizing a corresponding authoring function. For example, if a television is a targeted platform, menu options may be defined, using the rules set, to allow only larger font sizes to be selected. Restated, the rules set may be employed to limit the options to those suitable for the target platform. Font selection menu 200 depicts a menu listing font size choices. The font sizes displayed reflect the set of rules employed. The set of rules may be organized in a text-based file and may be compliant with XML (Extensible Markup Language). Code example 202 shows a sample XML tag <FONTSIZES> containing font sizes that may be employed to populate font selection menu 200 with choices available to the user. Code example 202 may be representative of fonts employed for web browser display. The utilization rules to define authoring options may be applied to a range of variables including fonts, font size, font colors, background colors, and other display characteristics, for example.

FIG. 3 is a code example for checking an authoring action and applying a rule. Code example 300 starts at step 302 where an action corresponding to an action taken by a user of an authoring system is located. A sequence of steps is contained between the ACTION tags. Step 304 indicates a check to be performed and in this example, the size of a placed graphic is checked. Step 306 indicates a condition of the check, the condition in this example being if the size of the graphic is greater than or equal to 64,000 bytes. Step 308 is displayed if the condition of step 306 is true and may be employed to display a message “Graphics larger than 64,000 bytes might take too long to access”. Such messages may also be employed to provide recommendations and suggestions to improve and simplify the authoring process. Step 310 is also executed if the condition of step 306 is true and in this case causes placement of the graphic to be aborted. In a similar manner to the previous example, checks of attributes of other authoring actions may be identified by the action and a sequence of steps may be executed in response to the authoring action. The sequence of steps may perform an range of functions including, object placement for television overscan, color selection between foreground and background, and conditions that may result in flicker in interlaced displays, for example.

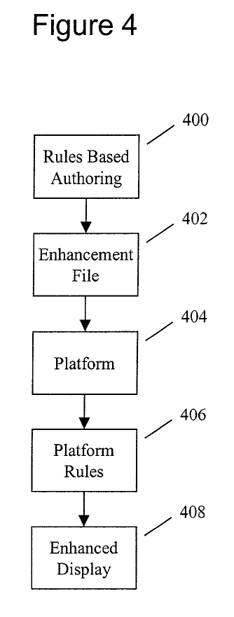

The present invention may also be implemented in a distributed manner wherein a first set of rules are applied in the authoring process and a second set of rules may be applied by the display platform. For example, a low-resolution enhancement may be suitable for television and browser display. The enhancement may contain pure colors for browser display. A television set-top box or other receiving apparatus may be employed to convert pure color to colors suitable for television. FIG. 4 depicts a method employing authoring and platform-based rules. Rules based authoring 400 is employed to create enhancement file 402. Enhancement file 402 is transferred to platform 404 where platform rules 406 may be employed to modify or reject enhancement information to produce enhanced display 408. By implementing a rules set in authoring and platform display, enhancements that are of greater detail or complexity than the ‘lowest common denominator’may be displayed.

The rules (rule set) of the present invention may be described in a text-based file. As previously noted, one embodiment of the present invention may employ a text based file compliant with XML (Extensible Markup Language). Advantageously, the rule set, as a text based file, is easily extensible, is easily built, queried and maintained. Using a standard scripting language such as XML makes the rules available to a variety of software applications that can use standard programming languages, such as XSL, for example, to consult the rule set as well. The rules may be organized into those that govern the basic interactive platform (e.g. a browser) and those that drive the interactive platform (e.g. the Microsoft Internet Explorer™ or Netscape Navigator™ browser). Each rule may be established with a variety of conditions including warnings, recommended values, suggestions, or a set of permissible values. Using the rules of the present invention, the constraints of developing interactive streaming media content may be fully described to the author creating the interactive content in the form of available options such as available fonts, for example, recommendations, such as usage of graphic sizes of under 64 KB, for example, and alerts such as a specific platform not supporting the selected function. As new versions of a browser or other platforms become available, the rule set may be enhanced to employ new or increased capabilities.

The present invention may also be applied to existing media enhancement files wherein colors may be translated, font sizes may be adjusted, displayable elements may be repositioned, files may be converted to another format (such as converting a JPEG image to GIF to support some platforms) and some elements may be discarded. Further, processing of an existing file may be performed to determine download time for a specified data transfer rate.

The foregoing description of the invention has been presented for purposes of illustration and description. It is not intended to be exhaustive or to limit the invention to the precise form disclosed, and other modifications and variations may be possible in light in the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for creating a media enhancement file comprising:
establishing a set of rules describing at least one constraint for each of at least two display platforms;
employing said set of rules to define options in an authoring program;
employing said authoring program to perform an authoring action; and
saving a media enhancement file.

2. The method of claim 1 further comprising:
a post processing program operable to apply a post processing set of rules to said enhancement file.

3. The method of claim 1 wherein said set of rules further comprises:
a text file.

4. The method of claim 1 wherein said set of rules further comprises:
an XML compliant file.

5. The method of claim 1 further comprising:
creating a set of platform rules that may be downloaded to a display platform.

6. The method of claim 5 further comprising:
transferring said set of platform rules to a display platform.

7. The method of claim 1 further comprising:
checking if a rule exists for said authoring action;

8. The method of claim 7 further comprising:
performing a step associated with said rule for said authoring action if said rule exists; and

9. The method of claim 8 wherein said step of performing a step comprises:
checking the size of a graphic element.

10. The method of claim 8 wherein said step of performing a step comprises:
checking the format of a graphic element.

11. The method of claim 8 wherein said step of performing a step comprises:
checking the color of a displayable element.

12. A set of rules for a display platform comprising:
a set of allowable font sizes;
a set of fonts;
a set of colors; and
a comment that may be displayed if a value is selected by an authoring program wherein said value is not in agreement with values contained in said set of rules.

13. A system for authoring media enhancements comprising:
a computer;
an enhancement authoring program;
a rules set; and
a program operable to constrain an editing option in said enhancement authoring program to reflect a limitation in said rules set.

14. The system of claim 13 further comprising:
a program operable to check if a rule exists for an action performed utilizing said authoring program and to execute a step associated with said rule if said rule exists.

15. A media enhancement file created though the steps of:
establishing a set of rules describing at least one constraint for each of at least two display platforms.
employing said set of rules to define options in an authoring program;
employing said authoring program to perform an authoring action; and
saving a media enhancement file.

16. The media enhancement file of claim 15 further comprising the step of:
checking if a rule exists for said authoring action.

17. The media enhancement file of claim 16 further comprising the step of:
performing a step associated with said rule for said authoring action if said rule exists.
